(19) United States
(12) Patent Application Publication
(10) Pub. No.: US 2025/0231064 A1
(43) Pub. Date: Jul. 17, 2025

(54) FLEX-SPECTRUM OPTICAL DETECTOR

(71) Applicant: Lumentum Operations LLC, San Jose, CA (US)

(72) Inventors: Patrick LANGLOIS, Gatineau (CA); Barrie P. KEYWORTH, Ottawa (CA); Paul Dwight COLBOURNE, Ottawa (CA)

(21) Appl. No.: 18/790,928

(22) Filed: Jul. 31, 2024

Related U.S. Application Data
(60) Provisional application No. 63/620,080, filed on Jan. 11, 2024.

(51) Int. Cl. G01J 3/28; G01J 3/18; G01J 3/45

(52) U.S. Cl. CPC G01J 3/2803; G01J 3/18; G01J 3/2823; G01J 3/45; G01J 2003/2813; G01J 2003/2826; G01J 2003/451

(57) ABSTRACT

An optical device may include a separating element to separate an optical signal into a plurality of spectral bands that are spatially or angularly separated along a band separation direction. Spectral ranges may differ among each spectral band of the plurality of spectral bands. The optical device may include a dispersive element comprising a plurality of dispersive regions. A dispersive region of the plurality of dispersive regions may disperse spectral components of a spectral band, of the plurality of spectral bands, along a dispersion direction to form a dispersed spectral band. The optical device may include a plurality of optical elements. An optical element of the plurality of optical elements may manipulate the dispersed spectral band in association with imaging the spectral band onto a detector area of a detector array. The optical device may include the detector array comprising the detector area.

### CROSS-REFERENCE TO RELATED APPLICATION

This patent application claims priority to U.S. Provisional Patent Application No. 63/620,080, filed on Jan. 11, 2024, and entitled “FLEX SPECTRUM SPECTROMETRY.” The disclosure of the prior Application is considered part of and is incorporated by reference into this patent application.

### TECHNICAL FIELD

The present disclosure relates generally to an optical detector and to a flex-spectrum optical detector.

### BACKGROUND

In spectrometry, a full spectrum response is conventionally dispersed such that the dispersed spectrum has the shape of a continuous elongated beam (with a large width-to-height aspect ratio) comprised of dispersed spectral bands. Conventionally, the dispersed spectral bands are arranged in a “linear” one-dimensional (1D) sequence from one edge of a beam to another edge of the beam, either without any discontinuity, or with only one spectral band imaged in a direction perpendicular to the direction of dispersion, for any detector pixel location along the direction of dispersion. When performing spectroscopy, it is commonly desired to detect a response from a sample with high sensitivity and high resolution across the full spectrum (e.g., for Raman spectrometers, a spectral range above 100 nanometers (nm) (in wavelength) or above 3000 reciprocal centimeters (cm⁻¹) (in wavenumbers)).

### SUMMARY

In some implementations, an optical device includes a separating element to separate an optical signal into a plurality of spectral bands that are spatially or angularly separated along a band separation direction, wherein spectral ranges differ among each spectral band of the plurality of spectral bands; a dispersive element comprising a plurality of dispersive regions, wherein a dispersive region of the plurality of dispersive regions is to disperse spectral components of a spectral band, of the plurality of spectral bands, along a dispersion direction to form a dispersed spectral band; a plurality of optical elements, wherein an optical element of the plurality of optical elements is to manipulate the dispersed spectral band in association with imaging the spectral band onto a detector area of a detector array; and the detector array comprising the detector area.

In some implementations, an optical device includes a separating element to separate an optical signal into a plurality of spectral bands having different spectral ranges and being spatially or angularly separated along a band separation direction; a plurality of optical elements, wherein an optical element of the plurality of optical elements is to manipulate a spectral band, of the plurality of spectral bands, in association with imaging the spectral band onto a detector area; and a detector array comprising the detector area.

In some implementations, a method includes separating, by a separating element of an optical device, an optical signal into a plurality of spectral bands each having a different spectral range and being spatially or angularly separated along a band separation direction; dispersing, by a dispersive element of the optical device, spectral components of a spectral band, of the plurality of spectral bands, along a dispersion direction to form a dispersed spectral band; and manipulating, by an optical element of the optical device, the dispersed spectral band in association with imaging the spectral band onto a detector area of a detector array of the optical device.

### BRIEF DESCRIPTION OF THE DRAWINGS

FIG. 1 is a diagram illustrating an example implementation of a flex-spectrum optical detector described herein.

FIG. 2 illustrates an example associated with the optical device that provides flexible segmentation and arrangement of a full spectrum.

FIGS. 3 and 4 are diagrams associated with increasing a dynamic range and sensitivity as enabled by an optical device described herein.

FIGS. 5-7 are diagrams illustrating example implementations of a separating element described herein.

FIG. 8 is a flowchart of an example process associated with a flex-spectrum optical detector described herein.

### DETAILED DESCRIPTION

The following detailed description of example implementations refers to the accompanying drawings. The same reference numbers in different drawings may identify the same or similar elements.

In spectrometry, a spectrograph is conventionally designed to provide light in the form of a single, non-segmented, linear optical beam containing a full spectral range interrogated by the spectrograph at a dispersive element of the spectrograph. The dispersive element disperses the light, and the dispersed light is projected as a continuous, non-segmented, linear image on a detector of the spectrograph. Here, the dispersed spectrum traditionally has the shape of a continuous elongated beam (with a large width-to-height aspect ratio) comprised of dispersed spectral components that are arranged in a “linear” 1D sequence from one edge of a beam to another edge of the beam, either without any discontinuity, or with only one spectral component imaged in a direction perpendicular to a direction of dispersion, for any detector pixel location along the dispersion direction. When performing spectroscopy, it is commonly desired to detect a response from a sample with high sensitivity and high resolution across the full spectrum (e.g., for Raman spectrometers, a spectral range above 100 nanometers (nm) (in wavelength) or above 3000 reciprocal centimeters (cm⁻¹) (in wavenumbers)). However, this is difficult to efficiently implement in practice. For example, if a high sensitivity and high-resolution detector array is required across a full spectrum, the physical design of the detector would have to accommodate a large width-to-height aspect ratio, which leads to inefficient use of physical space in a spectrometer system. Accordingly, it would be advantageous to discard the conventional 1D shape of the dispersed spectrum and avoid the large aspect ratio of the detector and be compatible with more typical 2D imaging detector arrays.

Additionally, any dispersed spectrum has two important attributes: spectral range and spectral resolution. These attributes conflict with one another for a fixed spectrum physical width. That is, for a given spectral range, there is a given spectral resolution. Increasing the resolution leads to an increased spectral width for a fixed spectral range, or a reduced spectral range for a fixed spectral width. These constraints are present for a 1D spectrum imaged on a detector. When performing spectroscopy, it is common for all spectral bands within the full spectrum response to have nominally the same degree of sensitivity and resolution. However, most conventional spectroscopy systems aim to identify specific characteristics for which one or more particular spectral bands can provide more useful identifying information, while other spectral bands may provide minimal identifying information. This can make poor use of the detector if all spectral bands have the same sensitivity and resolution. Accordingly, it would be advantageous to provide greater sensitivity and resolution for spectral bands that provide more useful identifying information, and lower sensitivity and resolution for spectral bands that provide less useful identifying information. Similarly, some spectral bands of the full spectrum may provide no useful information at all and, therefore, avoiding imaging those spectral bands on the detector would be advantageous.

A conventional two-dimensional (2D) technique can in some cases be used to divide (e.g., through a beam-splitter) a full spectrum into several beams, each containing the full spectral range. Then, different spectral range portions of each beam are imaged onto different detectors. Notably, according to this conventional 2D technique, each beam includes the full spectrum at a fraction of the original power, and then only a fraction of different spectral bands from each beam are imaged onto a detector. This wastes power because the original power is split into each full-spectrum beam and then the portions of each beam that are not imaged onto the detector are wasted. Thus, even those spectral ranges that are imaged onto a portion of the detector include only a fraction of the original power in that spectral range. Wasted power also reduces sensitivity. Accordingly, it would be advantageous to image as much power from the full spectrum response onto the detector as possible.

Implementations described herein provide techniques and apparatuses for measurement of spectral responses in which a full spectrum response can be divided into spectral bands (e.g., sub-spectra of any spectral range, resolution, or dynamic range), and each spectral band can be directed through dispersion and to a desired physical location on a detector array, while preserving power of the full spectrum response. In other words, the techniques and apparatuses described herein can be implemented to separate a full spectral response into a group of distinct spectral bands (e.g., sub-spectra) in wavelength or wavenumber with minimal power loss, and these spectral bands can then be independently manipulated or rearranged before spectral dispersion and imaging onto a detector (e.g., a 2D detector). The techniques and apparatuses described herein avoid power loss when splitting the full spectrum response; decouple bandwidth, resolution, and dynamic range constraints for each spectral band; increase efficiency with respect to use of a 2D detector; and enable a more compact spectrograph.

The techniques and apparatuses described herein enable a comparatively more compact spectrograph by separating a full spectrum of incident light into spectral bands with no loss of power (other than power loss caused by non-idealities of optical components performing the separating function), and spatially re-arranging the spectral bands (e.g., into a stack) before passing the spectral bands to a dispersive element. Such a design may enable higher optical resolution per spectral band from the dispersive element and may in some designs enable a reduced size of the dispersive element in a dispersion direction. After dispersion, the dispersed spectral bands are projected and imaged (e.g., in a stack) onto a 2D detector array, thereby enabling higher detector resolution and increasing efficiency with respect to usage of an active area of the detector array.

The techniques and apparatuses described herein incorporate spectral banding at a front-end, which splits a full spectral range into multiple spectral bands (e.g., a set of adjacent, sequential or different spectral ranges) before dispersion. In some implementations, the spectral bands may be non-overlapping, or may be partially (e.g., minimally) overlapping or nearly non-overlapping (e.g., to allow for redundancy or tolerance to manufacturing when attempting to create non-overlapping or adjacent spectral bands). In some implementations, the spectral bands can be rearranged in space and stacked onto a dispersive element in a non-dispersive direction (e.g., a direction perpendicular to the dispersion direction), thereby creating a 2D arrangement of spectral bands. In some implementations, the dispersive element may comprise multiple dispersive regions (e.g., each with different dispersive properties) which can map to the spectral bands incident thereon. Each dispersive region of the dispersive element can thus disperse and redirect light incident thereon independently of the other dispersive regions.

After dispersion, the spatial arrangement of the dispersed spectral bands can be maintained or further rearranged as the dispersed spectral bands are directed to a detector array. For example, in some implementations, the dispersed spectral bands can be arranged in space and stacked onto a 2D detector array in a band separating direction. The spectral bands can be rearranged in a variety of ways (e.g., depending on the selected spectral range divisions and resolution targets). In general, the number of spectral bands, the spectral ranges of the spectral bands, and the spectral resolutions of the spectral bands can be varied and set freely and independently of each other in accordance with a desired performance target for a given application (e.g., Raman, time-gated Raman, spatially offset Raman spectroscopy (SORS), fluorescence, or the like). For example, a spectrum formed by the sum of all spectral bands may be non-continuous (e.g., interrupted by one or more gaps) or may have different spectral resolutions for different sub-spectra. Additionally, or alternatively, a dynamic range and the sensitivity desired for measurement of each spectral band can be set freely and independently of the other spectral bands by controlling a “height” (e.g., in a direction orthogonal to the dispersion direction) that each spectral band is imaged onto the detector. While increasing the detector area illuminated by a particular spectral band does not change the total amount of photons in that spectral band, increasing the detector area increases the dynamic range that can be achieved for that spectral band and increases a saturation limit of the detector for wavelengths in that spectral band because the photons are spread to more pixels of the detector. In some implementations, the techniques and apparatuses described herein enable one or more spectral bands (e.g., one or more spectral bands that are not of interest) to be removed. For example, one or more spectral bands can be removed from imaging on the detector during splitting of the spectrum, during dispersion, or during spatial or angular re-arrangement (e.g., before or after dispersion).

Notably, the techniques and apparatuses described herein enable segmentation of the full spectrum in a different manner than the conventional 2D technique described above. In some implementations, the full spectrum is separated into spectral bands that are different in wavelength/wavenumber range and which are then rearranged spatially to have a 2D arrangement in which multiple spectral bands (which together, can cover the full spectral range and include nearly all the power of the original spectrum) are stacked in a direction perpendicular to the dispersion direction. In such an arrangement, higher resolution can be achieved, as compared to a 1D arrangement (i.e., on a 1D detector) of the same width. For comparison, achieving the same full spectral range with increased resolution with a linear, 1D, response would require a detector having a spectral dispersion dimension increased by a factor equivalent to the number of spectral bands created (e.g., assuming that all of the spectral bands have the same width and cover the same spectral range). As compared to the conventional 2D technique, there is minimal power loss because the full spectrum has been divided into separate, (optionally) non-overlapping, spectral bands including nearly all of the power of the full spectrum. This flex-spectrum spectrometry technique allows maximal use of an active area of a detector, which may be a rectangularly shaped (e.g., a low width-to-height ratio) 2D detector array. In some implementations, the full spectrum can be separated into separate non-overlapping spectral bands that are rearranged spatially to stack in alignment onto a low width-to-height ratio active area of a 2D detector array.

For the same physical size as a conventional 1D solution, the techniques and apparatuses described herein can achieve a higher resolution and/or cover a larger spectral range. Alternatively, the techniques and apparatuses described herein can achieve the same performance in a reduced width of the detector in the dispersion direction, which is typically the largest dimension of the detector used in spectrometry, at a fraction of the physical size of the conventional 1D technique. Segmenting the spectrum to reduce the width, while adding to the height from the rearrangement of the segmented spectral bands in a direction perpendicular to the dispersion direction (i.e., the band separation direction) leads to a favorable detector geometry with respect to enabling a compact size (e.g., volume) spectrometer or spectrometry system, or with respect to compatibility with a wider selection of commercially available large pixel count detector arrays (e.g., SPAD arrays). The addition of height on the detector to cover the additional spectral bands leads to marginal or no increase in height of the spectrometer, while the reduction in width of the detector leads to significant footprint reduction due to a smaller angular spread of the dispersed sub-spectra and their smaller width on a plane of the detector. As a consequence of the reduced width of the detector, the sizes of optical and mechanical components within the spectrometer are also reduced, which leads to a reduced size, weight, and (potentially) power consumption of the spectrometer system.

As described above, for a given detector width along the dispersion direction, the techniques and apparatuses described herein can achieve higher resolution and/or cover a larger spectral range. Performance attributes of a spectrometer are no longer fixed or constrained by the detector width. Adding a second dimension to the spectral arrangement allows for this flexibility. The techniques and apparatuses described herein enable varying the detection dynamic range and sensitivity across the full spectral range. Because the spectrum is segmented, each spectral band can be adjusted to cover any specific height (i.e., a number of pixels in the band separation direction) on an active area of the detector. Hence, detection dynamic range and sensitivity (which scales with the height of a spectral component on the detector active area) can be modulated across the various spectral bands to reflect, for example, target relative importance of the various spectral bands in a spectrometry measurement.

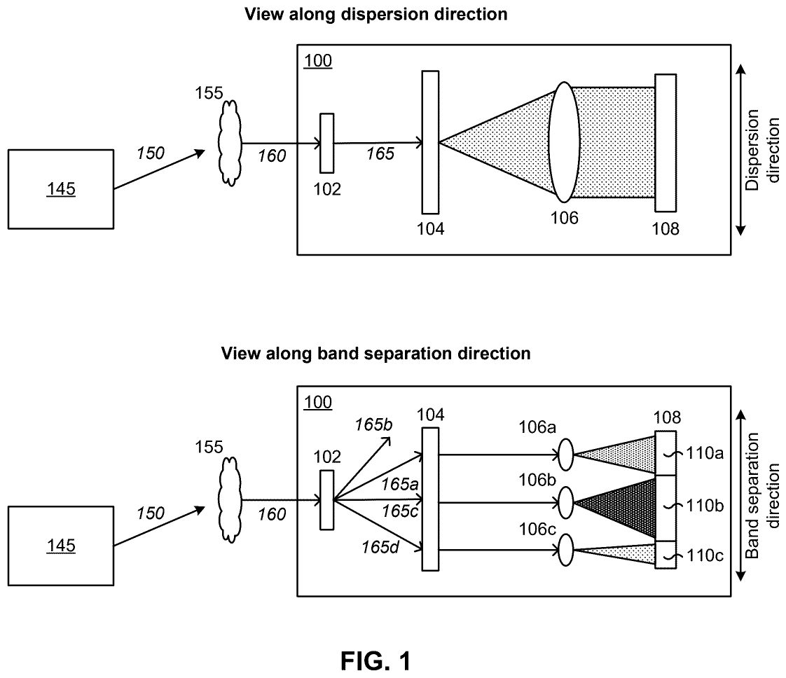

FIG. 1 is a diagram illustrating an example implementation of a flex-spectrum optical detector (herein referred to as optical device 100) described herein. As shown in FIG. 1, an optical source 145 emits source light 150 (e.g., a laser beam) that is incident on a sample 155. An optical signal 160 emerging from the sample 155 (e.g., an altered transmitted signal from the optical source 145, a signal generated by the sample 155 as a consequence of excitation by the source light 150, or the like) includes spectral information (i.e., a spectral response) which is directed to the optical device 100. As shown in FIG. 1, the optical device 100 comprises a separating element 102, a dispersive element 104, a plurality of optical elements 106 (e.g., comprising optical element 106a, optical element 106b, and optical element 106c), and a detector array 108 comprising a set of detector areas 110 (e.g., detector area 110a, detector area 110b, detector area 110c). The top diagram in FIG. 1 illustrates an example of a view of the optical device 100 along a dispersion direction (i.e., a direction along which the dispersive element 104 disperses spectral bands 165, as described below), while the bottom diagram in FIG. 1 illustrates an example of a view of the optical device 100 along a band separation direction (i.e., a direction along which the separating element 102 separates the optical signal 160 into a plurality of spectral bands 165, as described below).

The separating element 102 comprises one or more elements to separate the optical signal 160 into a plurality of spectral bands 165. That is, the separating element 102 comprises one or more elements that segment (e.g., by spectral range) and rearrange (e.g., spatially/angularly) the spectral response from the sample 155 into spatially and/or angularly re-arranged spectral bands (e.g., spectral band 165a, spectral band 165b, spectral band 165c, and spectral band 165d). In some implementations, the direction along which the separating element 102 spatially or angularly separates the optical signal 160 into the plurality of spectral bands 165 is referred to as the band separation direction. In some implementations, the band separation direction is perpendicular to a dispersion direction (e.g., a direction along which the dispersive element 104 disperses spectral bands 165). Notably, while the band separation direction being perpendicular to the dispersion direction may be used for practical purposes, a geometry in which the band separation direction is not perpendicular to the dispersion direction may be used in some implementations (e.g., depending on a detector geometry). In some implementations, the separation of the optical signal 160 (e.g., the segmentation and rearrangement of the spectrum) is performed in a single direction—the band separation direction. As one example, the separating element 102 may change an angle of wavelengths of the optical signal 160 so as to create a continuous spatial spectrum spread in the band separation direction.

The separating element 102 can be configured so as to provide any number of spectral bands with different properties (e.g., physical size and orientation in space, spectral range, and/or spectral width). In some implementations, spectral ranges differ among each spectral band 165 of the plurality of spectral bands 165. In some implementations, spectral bands 165 in the plurality of spectral bands 165 may be substantially non-overlapping (e.g., such that each spectral band 165 covers a substantially different frequency range). Such an implementation may be utilized to, for example, maximize a spectral range covered by the banding of the optical signal 160 provided by the separating element 102. In some such implementations, an overlap between a given pair of adjacent spectral bands 165 may be small (e.g., a maximum overlap in a range from approximately 2% to approximately 10%). Such an overlap may be utilized to, for example, avoid gaps between spectral bands 165 that could otherwise arise from design or manufacturing non-idealities. Additionally, or alternatively, spectral bands 165 in the plurality of spectral bands 165 may be substantially overlapping (e.g., an overlap in frequency range that is greater than approximately 10%) so as to provide significant spectral redundancy. As an example, an application may require the same sub-band spectral range (e.g., approximately 100% overlap) to be detected by two different detector areas 110 of the detector array 108 (e.g., when the two detector areas 110 have different detector properties, when power in each “identical” spectral band 165 is intentionally made different when incident on a respective dedicated detector area 110, or the like).

In some implementations, the separating element 12 may be configured such that optical power differs among spectral bands 165 (e.g., such that an optical power of a given spectral band 165 is controlled to a desired degree or intentionally differs from an optical power of another spectral band 165). Such an implementation may be used when, for example, different detector areas 120 have different input optical power saturation levels (or thresholds) and having the different detector areas 120 behave similarly is desirable. As another example, such an implementation may be used when the use of a detector area 120 with different input power levels is desirable to probe the detector area 120 in different input optical power saturation regimes (e.g., multiple spectral bands 165 with the same spectral range but with different optical power could be sent to multiple nominally identical detector areas 120).

In some implementations, the separating element 102 may segment the optical signal 160 into spectral bands with no loss of power (e.g., other than power loss caused by component non-idealities). Notably, conventional techniques are based on power splitting rather than spectral separation. In other words, the conventional techniques split an optical signal into N (N>1) roughly equivalent sub-beams, where each sub-beam has 1/N^{th} of the power from each spectral band of the full spectrum. Conversely, the separation provided by the separating element 102 separates the optical signal 160 into the plurality of spectral bands 165 with all of the power from its respective band and none of the power from the other bands (within reasonable component non-idealities). Accordingly, the separation provided by the separating element 102 preserves the power that is relevant for each spectral band, which enables increased throughput, thereby enabling increased sensitivity for spectrometry. Additionally, preservation of power that is relevant for each spectral enables increased measurement speed for spectrometry. For example, a SNR for a given detected spectral component (e.g., a Raman peak within a portion of the spectrum) for a given detection time (i.e., a photon collection time) is roughly proportional to a square root of a number of detected Raman photons. For a given excitation pulse energy and number of excitation pulses (or equivalently, a detection time window), there are comparatively more Raman photons reaching the detector within that spectral component and, therefore, a higher SNR is achieved with spectral splitting (as compared power splitting). This means that, for the same SNR, spectral splitting requires a smaller number of pulses and, therefore, a reduced detection time window, which is equivalent to an increase in measurement speed.

The dispersive element 104 comprises one or more elements to disperse spectral components of spectral bands 165 to form dispersed spectral bands 165. That is, the dispersive element 104 comprises one or more elements that disperse the spectral bands 165 (e.g., the spectral bands 165a through 165d,) to form a plurality of dispersed spectral bands 165 (e.g., dispersed spectral band 165a, dispersed spectral band 165c, and dispersed spectral band 165d in the example shown in FIG. 1). In some implementations, the dispersive element 104 may include one or more elements capable of spatially separating incoming light into different spectral components (e.g., wavelengths). For example, the dispersive element 104 may include a diffraction grating, a prism, or any other wavelength dispersive element. In one example implementation, the spatially separated spectral bands 165 are incident upon a diffraction grating with spatially separated sections (which may or may not be contiguous), with each section being designed to operate with the corresponding incident spectral band 165. In some implementations, the direction along which the dispersive element 104 disperses a spectral band 165 is referred to as the dispersion direction. In some implementations, the dispersive element 104 comprises a plurality of dispersive regions (e.g., each to disperse a respective one of the plurality of spectral bands 165). In some implementations, the plurality of dispersive regions may be stacked along the band separation direction (e.g., perpendicular to the dispersion direction). In some implementations, a given dispersive region of the dispersive element 104 disperses a spectral band 165 incident thereon independently of dispersion by other dispersive regions of the dispersive element 104. For example, in some implementations, the plurality of dispersive regions may be monolithically patterned (or mechanically tiled) onto a single dispersive element 104, with each dispersive region having a respective (e.g., different) set of dispersive properties.

In operation, the dispersive element 104 serves to physically separate spectral components forming a given spectral band 165 such that the spectral components of the given spectral band 165 emerge from the dispersive element 104 with different angles and positions so as to form a dispersed spectral band 165. In some implementations, the dispersive regions of the dispersive element 104 may operate differently on each spectral band 165 so as to produce dispersed spectral bands 165 having different optical properties (e.g., physical size and orientation in space, spectral range, spectral width, spectral resolution, or the like). For example, a given dispersive region of the dispersive element 104 may segment or separate angularly and spatially a continuous spatial spectrum into individual bands. In some implementations, the dispersive element 104 may define a spectral range of a given spectral band 165.

The plurality of optical elements 106 comprises one or more elements to manipulate the dispersed spectral bands 165 in association with imaging the spectral bands 165 onto detector areas 110 of the detector array 108. In some implementations, the plurality of optical elements 106 comprises an imaging sub-system for spectral bands 165 to be imaged onto the detector array 108. In some implementations, the plurality of optical elements 106 includes a plurality of elements capable of manipulating a location, a size, and/or an orientation/direction of spectral bands 165 in order to image one or more spectral bands 165 from the plurality of spectral bands 165 onto the detector array 108 and with a particular arrangement (e.g., as dictated by the size of the detector array 108 and/or performance attributes and/or functional criteria). For example, a given optical element 106 may include one or more lenses, prisms, wedges, mirrors, diffraction gratings, bulk optics, or the like and combinations thereof. In some implementations, a given optical element 106 can preserve one or more properties (e.g., a spectral range, a spectral resolution, a detection dynamic range and sensitivity, a physical size or location on a plane of the detector array 108, or the like) of a given spectral band 165 and image such properties onto a particular detector area 110 of the detector array 108. Additionally, or alternatively, a given optical element 106 can modify one or more properties of a given spectral band 165. For example, an optical element 106 can be designed so that a width of the detector array 108 is filled so as to provide a highest resolution and/or so as to determine a height of the detector array 108 that is used for each respective spectral band 165 (e.g., to control dynamic range and sensitivity). In some implementations, the plurality of optical elements 106 may serve to arrange the dispersed spectral bands 165 so as to optimize usage of the detector array 108 (e.g., to maximize an area utilized on the detector array 108, to maximize optical resolution, to utilize a specific detector area 110 on the detector array 108 for a specific spectral band 165, or the like). For example, the plurality of optical elements 106 can expand the dispersed spectral bands 165 to match a width of the detector array 108 and stack each spectral band 165 in detector areas 110 with respective heights on the detector array 108. In some implementations, the plurality of optical elements 106 may manipulate (e.g., direct, steer, focus, collimate, converge, expand, or the like) the dispersed spectral band 165 such that images of the spectral bands 165 are stacked along the band separation direction at a plane of the detector area 110. For example, the plurality of optical elements 106 may in some implementations provide spatial rearrangement of the plurality of spectral bands 165 on a plane of the detector area 110. In some implementations, an optical element 106 in the plurality of optical elements 106 may manipulate (e.g., expand) a dispersed spectral band 165 such that a size of the dispersed spectral band 165 along the dispersion direction matches a size of a detector area 110 along the dispersion direction (e.g., an area of the detector array 108 on which the spectral band 165 is to be imaged). Similarly, in some implementations, the optical element 106 may manipulate (e.g., expand) the dispersed spectral band 165 such that a size of the dispersed spectral band 165 in the band separation direction matches a size of the detector area 110 along the band separation direction. In this way, the spatial arrangement of the dispersed spectral bands 165 at the detector area 110 can be controlled so as to maximize the use of a particular detector geometry (e.g., a rectangular 2D detector array 108).

The detector array 108 comprises one or more detector areas 110 on which one or more of the spectral bands 165 are imaged. In some implementations, as indicated in FIG. 1, the detector area 110 may comprise a plurality of detector areas 110 that are stacked along the band separation direction. In some implementations, the detector array 108 may comprise a 2D array (e.g., a 2D array of detector areas 110). Additionally, or alternatively, the detector array 108 may comprise a plurality of 1D detector arrays (e.g., a plurality of 1D detector arrays that are stacked along the band separation direction). Such an implementation may, for example, extend detection capabilities (e.g., a spectral range, a spectral resolution, a detection dynamic range, a detection sensitivity, or the like) of the optical device 100. In some implementations, the detector array 108 may comprise a single photon avalanche diode (SPAD) array (e.g., a high dynamic range and sensitivity, high temporal resolution (sub-nanosecond) SPAD array). Additionally, or alternatively, the detector array 108 may comprise an array of time-resolved photon counting detectors (e.g., an array of areas capable of associating a time stamp with each photon detected by a given area). Such detectors may also be referred to as time-binned photon counting detectors or time-tagged photon counting detectors. Alternatively, the detector array 118 may comprise a detector array comprising photon detectors that use another type of technology (e.g., an array of photon detectors that may or may not include time-resolved photon counting detectors). In some implementations, a size of a first detector area 110 of the plurality of detector areas 110 is different from a size of a second detector area 110 of the plurality of detector areas 110. In some implementations, a detector area 110 of the detector array 108 could be used for multiple spectral bands 165. Reuse of a detector area 110 may be enabled, for example, by multiplexing in the time domain in combination with an active element capable of selecting a spectral band 165 that is manipulated and imaged onto the given detector area 110 at a given point in time.

In some implementations, a size of a first detector area 110 of the detector array 108 in the dispersion direction matches a size of a second detector area 110 of the detector array 108 in the dispersion direction, and a size of the first detector area 110 in the band separation direction is different from a size of the second detector area 110 in the band separation direction. In such an implementation, greater sensitivity is provided for a spectral band 165 imaged to the first detector area 110 with the comparatively larger size. In this way, the dynamic range and the sensitivity desired for measurement of each spectral band 165 can be set freely and independently of the other spectral bands 165 by controlling the “height” in the band separation direction that each spectral band 165 is imaged onto the detector array 108. While increasing the size of the detector area 110 illuminated by a particular spectral band 165 does not change the total amount of photons in that spectral band 165, the size increase increases the dynamic range and sensitivity that can be achieved for that spectral band 165 (e.g., by reducing the impact of reset “dead-time” that occurs after a pixel detection event in SPAD arrays) and increases the saturation limit of the detector array 108 for wavelengths in that spectral band 165 because the photons are spread to more pixels of the detector array 108.

In the example shown in FIG. 1, the separating element 102 provides four spectral bands 165 (i.e., four sub-spectra), three of which (e.g., spectral band 165a, spectral band 165c, and spectral band 165d) are directed to the dispersive element 104 to be dispersed and then manipulated by respective optical elements 106 for imaging with three different geometries (e.g., different heights of each spectral band 165). An example of a resulting arrangement of the optical signal 160 into these three spectral bands 165 with different properties (e.g., height-dependent dynamic range and sensitivity, spectral range, spectral width covered, spectral resolution) is illustrated in FIG. 1 and with Table 1 below. Notably, in this example, spectral band 165b is not imaged at the detector array 108. That is, in some implementations, at least one spectral band 165 of the plurality of spectral bands 165 may not be imaged onto any detector area 110 of the detector array 108. Such an implementation may be used when, for example, some portion (e.g., spectral band 165b) of the full spectrum does not need to be measured or detected. In some implementations, the capability to have such spectral gaps in detection at the detector array 108 may enable enhancement of one or more other attributes of the detected spectral bands 165 (e.g., increased resolution, redundancy, read-out speed, or the like). Thus, in some implementations, a spectrum formed by a sum of a set of spectral bands 165 that is imaged on the detector array 108 is non-continuous (e.g., includes one or more spectral gaps). In some implementations, an optical power of a given spectral band 165, of the plurality of spectral bands 165, at the detector array 108 is more than 90% of an optical power of the spectral band 165 prior to the separating element 102. That is, spectral bands 165 can be imaged at the detector array 108 with no or minimal loss of power (other than power loss caused by non-idealities of optical components performing the separating function).

Notably, because spectral bands 165 can be stacked when imaged onto the detector array 108 (e.g., a 2D detector array), an angular range required of elements and optics of the optical device 100 is significantly reduced in the dispersion direction (e.g., as compared to a conventional device that uses a comparatively longer 1D detector). This reduces the physical size of the optical device 100, thereby enabling a more compact optical engine. Further, the optical device 100 can be applied to many existing spectroscopy techniques. For example, the optical device 100 may be used for Raman and fluorescent spectroscopy, and reading time of the detector array 108 may be time-gated and/or correlated with exposure of the sample 155 to the source light 150.

Further, according to the techniques described herein, a given spectral band 165 can in some implementations be directed to any detector area 110 of the detector array 108. An active area of the detector array 108 need not have the same dimension as an area given by a sum of areas of all of the spectral bands 165 to be detected at the plane of the detector array 108. In some implementations, the spectral bands 165 can be arranged to fit a width of the active area of the detector array 108, and a scanning mechanism can be used to move the spectral bands 165 in the band separation direction to fall onto the detector area 110 or to move the detector array 108 in the band separation direction to fall in the field of view of the desired spectral band(s) 165. This may enable the use of a reduced-size detector array 108 (e.g., a reduced size 1D array or a 2D array with fewer detector regions) whose width is set by the width of a single spectral band 165 to measure the entire spectrum (e.g., a sum of all the spectral bands 165).

In some implementations, one or more elements of the optical device 100 can be statically configured (e.g., using conventional optics). Additionally, or alternatively, one or more elements of the optical device 100 can be dynamically configured to, for example, allow a number of spectral bands 165 generated, a spectral range of each spectral band 165, a dynamic range and sensitivity (or height on the detector array 108) applied to each spectral band 165, and/or a location at which each spectral band 165 is imaged on the detector array 108 to be dynamically configured. A dynamic configuration may allow different spectral bands 165 from different pulses to be imaged onto the detector array 108. In some implementations, read-out of one or more detector areas 110 of the detector array 108 can be performed using a variety of techniques, such as using a global shutter or a rolling shutter. Further, in some implementations, one or more spectral bands 165 may be removed by the separating element 102 (e.g., as illustrated in FIG. 1). Additionally, or alternatively, one or more other elements of the optical device 10 may be configured to remove one or more spectral bands 165 (e.g., such that the one or more spectral bands 165 are not imaged onto the detector array 108), such as the dispersive element 104 or one or more optical elements 106.

An optical resolution is given by the dispersive element 104 (e.g., a grating resolution) regardless of characteristics of the detector array 108. A detector resolution is given by the detector array 108 (e.g., a size of pixels of the detector array 108) and is similarly independent of the dispersive element 104. The system resolution combines the optical resolution and the detector resolution. In the optical device 100, a best result that can be achieved is the optical resolution since, even if a better detector resolution is provided, the detector array 108 cannot sample at a higher resolution than provided by the dispersed spectral bands 165 provided by the dispersive element 104. In practice, a goal is to match the detector resolution to the optical resolution to avoid degrading the optical resolution without having unnecessary pixels. In some implementations, a spectral resolution of a first spectral band 165 of the plurality of spectral bands 165 is different from a spectral resolution of a second spectral band 165 of the plurality of spectral bands 165.

Spectral range is given by the range of wavenumber or wavelength that is included within a particular spectral response, signal, band, or sub-spectra. Spectral range is similar to a bandwidth in wavelengths. In the case of Raman spectroscopy, an example spectral range of the optical signal 160 may be more than approximately 100 nm (in wavelength) or more than approximately 3000 cm−1 (in wavenumbers). Further, an example spectral range of a given spectral band 165 may be between approximately 400 and 700 wavenumbers. In some implementations, a spectral range of the first spectral band 165 of the plurality of spectral bands 165 may be different from a spectral range of a second spectral band 165 of the plurality of spectral bands 165.

Dynamic range is a range of values that can be reported from a set of pixels of the detector array 108 with respect to a particular wavelength/wavenumber in a spectral band 165. In some implementations, by increasing the number of pixels per wavelength/wavenumber, the dynamic range for that wavelength/wavenumber can be increased (e.g., by reducing the impact of reset “dead-time” that occurs after a pixel detection event in SPAD arrays).

As indicated above, FIG. 1 is provided as an example. Other examples may differ from what is described with regard to FIG. 1. The number and arrangement of elements shown in FIG. 1 are provided as an example. In practice, there may be additional elements, fewer elements, different elements, or differently arranged elements than those shown in FIG. 1. Furthermore, two or more elements shown in FIG. 1 may be implemented within a single element, or a single element shown in FIG. 1 may be implemented as multiple, distributed elements. Additionally, or alternatively, a set of elements (e.g., one or more elements) shown in FIG. 1 may perform one or more functions described as being performed by another set of elements shown in FIG. 1.

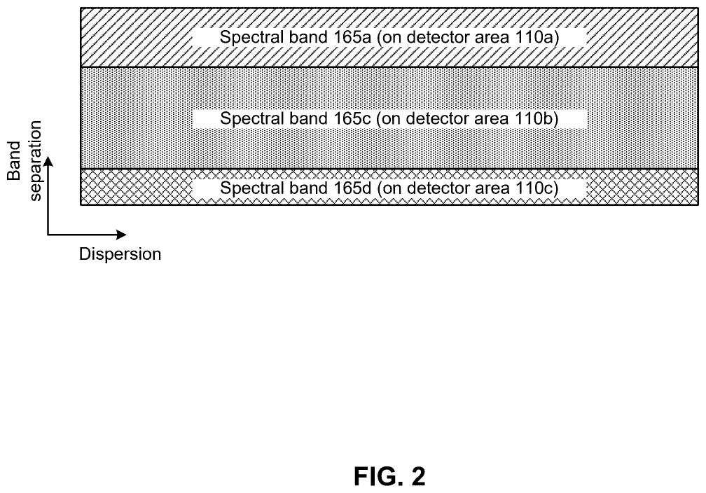

FIG. 2, in combination with Table 1 (below), illustrates an example associated with the optical device 100 that provides flexible segmentation and arrangement of a full spectrum. In the example shown in FIG. 2, the spectral bands 165 are arranged so that the spectral bands 165 are imaged in a stack in the band separation direction (e.g., a direction perpendicular to the dispersion direction) at the detector array 108. As noted above, the spectral bands 165 can be arranged in a variety of ways depending on, for example, a spectral range, a spectral resolution, and/or a detection dynamic range and sensitivity target. In some implementations, a number and areas of spectral bands 165 can be varied, and each spectral band 165 spectral range, resolution, dynamic range, and/or sensitivity can be set independently of those of the other spectral bands 165 (e.g., for the purpose of meeting specific performance targets for a given application). For example, portions of the full spectrum that do not need to be measured or detected (e.g., spectral band 165b) can in some implementations be skipped (e.g., avoided or rejected). As another example, specific pixels or detector areas 110 of the detector array 108 that cannot or should not be used can be avoided.

TABLE 1

| | | | Band | | | |
|---|---|---|---|---|---|---|
| | Relative | | height | | | |
| | importance | | (pixels) | | Spectral band | Spectral |
| Spectral | to sample | Detector | (size of | Spectral range | width | resolution |
| band # | identification | area # | sensor) | (wavenumbers) | (wavenumbers) | (wavenumbers) |
| 165a | Normal | 110a | 200 | 400-700 | 300 | 1.5 |
| 165b | Not | N/A | N/A | 700-1100 | 400 | N/A |
| | Monitored | | | | | |
| 165c | High | 110b | 400 | 1100-1600 | 500 | 0.5 |
| 65d | Low | 110c | 100 | 0-400 | 400 | 4 |

Table 1 presents a numeric example illustrating attributes of the different spectral bands 165 imaged on a 2D detector array 108 comprising three detector areas 110 as illustrated in FIG. 2. In this example, a height of an example detector area 110 is 700 pixels and an example spectral range (expressed as spectral shift from excitation wavelength) is 0 to 1600 wavenumbers. Here, one fraction of the full spectrum, spectral band 165b, is not measured or monitored and therefore is not imaged onto the detector array 108, while the remainder of the full spectrum is divided into spectral band 165a, spectral band 165c, and spectral band 165d with different spectral ranges, resolution, dynamic ranges and sensitivities (e.g., scaling with height on the detector array 108, referred to as band height in Table 1) and imaged onto different detector areas 110 of the detector array 108.

As indicated above, FIG. 2 is provided as an example. Other examples may differ from what is described with regard to FIG. 2.

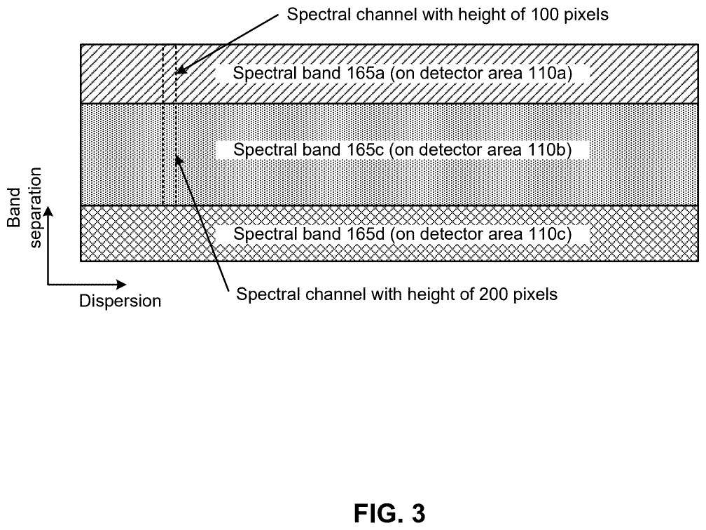

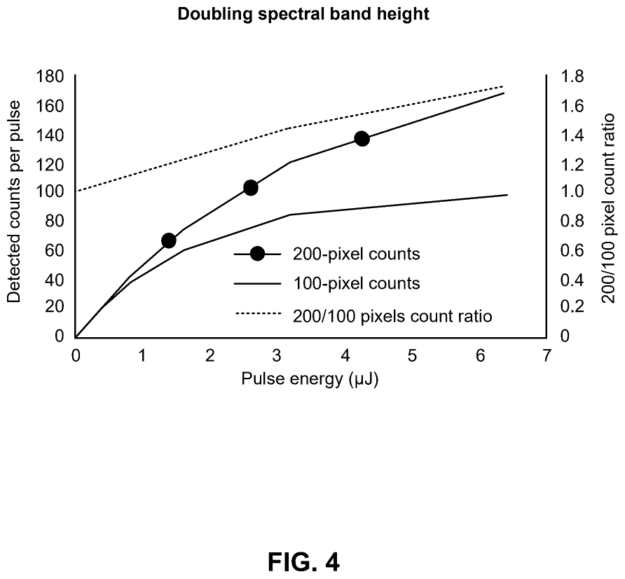

FIGS. 3 and 4 are diagrams associated with increasing a dynamic range and sensitivity as enabled by the optical device 100. In some implementations, a dynamic range and sensitivity can be increased without changing front-end light collection and spectral splitting. In one example implementation, back-end imaging optics (e.g., one or more optical elements 106) may be designed such that energy in one spectral band 165 is imaged with a different, larger, height on the detector array 108, at the expense of reduced height or number of other spectral bands 165 for a fixed-size detector area. Alternatively, in another example implementation, two or more spectral bands 165 can be made identical (e.g., spectral band 165a and spectral band 165d in FIG. 3), and power in those spectral bands 165 can be equally split.

In the example detector array 108 illustrated in FIG. 3, spectral band 165c has twice the height of spectral band 165a (e.g., 200 pixels versus 100 pixels) at the detector array 108 (e.g., a height of the detector area 110 at which the spectral band 165c is imaged is twice that of the detector area 110 at which the spectral band 165a is imaged). Here, if all spectral bands 165 have equal energy (e.g., power or throughput), then spectral band 165c would have a pulse energy per pixel reduced by a factor of 2 as compared to spectral band 165a (and spectral band 165d). The impact of reducing energy density (e.g., energy per pixel) on the detector array 108 is calculated in the diagram shown in FIG. 4 for two channel sizes: a spectral channel of a particular width and a height of 100 pixels and a spectral channel with the particular width and a height of 200 pixels. As shown in FIG. 4, the taller channel (i.e., the spectral channel with the height of 200 pixels) has a larger dynamic range for count detection, which leads to increased sensitivity. In the diagram shown in FIG. 4, if the pulse energy were further increased, the detected counts per pulse would eventually saturate the detector array 108, meaning that the detector array 108 could not detect more counts despite increases in pulse energy. In some implementations, by increasing the height (e.g., and number of pixels) allotted to a given spectral band 165, the sensitivity and saturation limit can be increased.

In some implementations, a first spectral band 165x with a comparatively smaller bandwidth can be imaged on a first detector area 110x of the detector array 108, and a second spectral band 165y with a comparatively larger bandwidth can be imaged on a second detector area 110y of the detector array 108, while a total width and pixel size (i.e., resolution) of the first detector area 110x in the dispersion direction matches a total width and pixel size (i.e., resolution) of the second detector area 110y in the dispersion direction. In this way, when the optical resolution of a first spectral band 165x matches the optical resolution of a second spectral band 165y, the first spectral band 165x may be provided with a higher spectral resolution than the second spectral band 165y (e.g., because each detector pixel receives fewer wave numbers for the first spectral band 165x with the comparatively smaller bandwidth).

As indicated above, FIGS. 3 and 4 are provided as examples. Other examples may differ from what is described with regard to FIGS. 3 and 4.

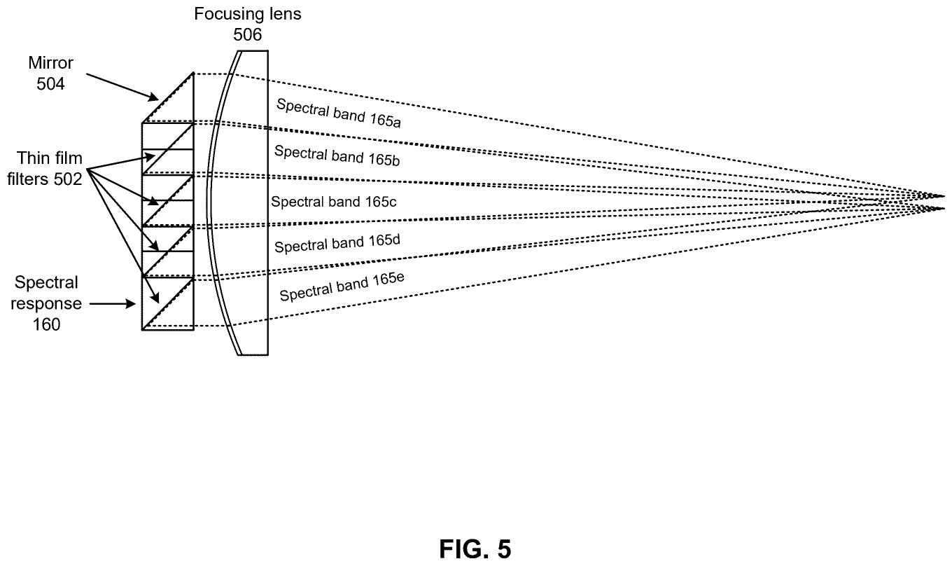

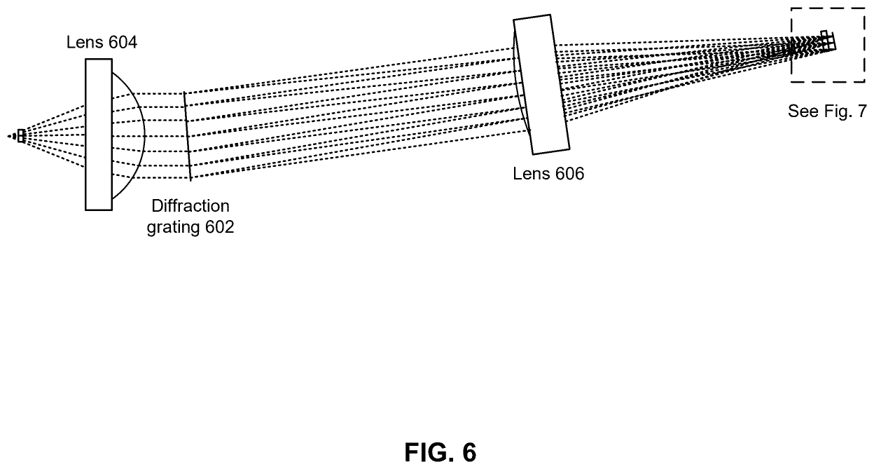

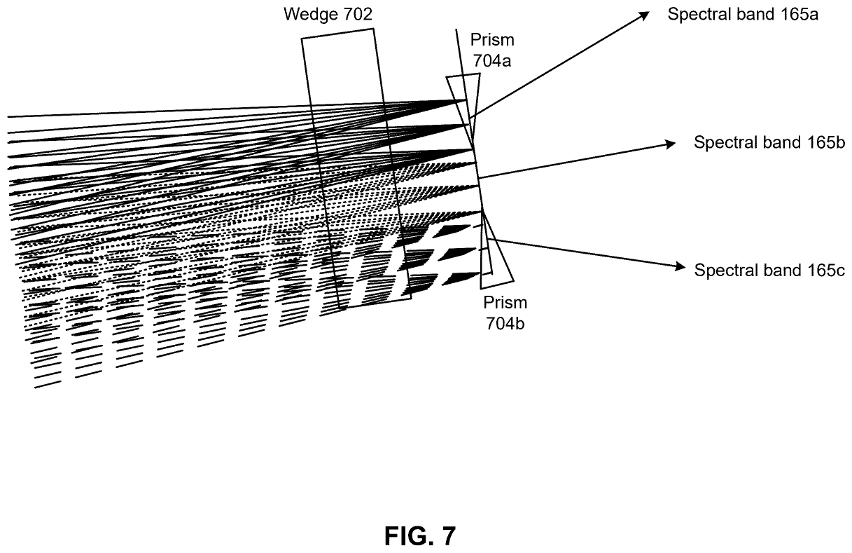

FIGS. 5-7 are diagrams illustrating example implementations of a separating element 102 described herein. In some implementations, as noted above, the separating element 102 may include one or more elements capable of spatially or angularly separating the optical signal 160 into multiple spectral bands 165 such that each spectral band 165 is spatially or angularly separated from other spectral bands 165. In some implementations, the separating element 102 may comprise a plurality of thin film interference filters, each associated with a different spectral band 165 of the plurality of spectral bands 165. FIG. 5 is a diagram illustrating an example implementation of a separating element 102 comprising a plurality of (e.g., four) thin film interference filters 502. Additionally, or alternatively, these may comprise a diffraction grating. FIGS. 6 and 7 are diagrams illustrating an example implementation of a separating element 102 comprising a diffraction grating 602. Additionally, or alternatively, the separating element 102 may comprise one or more other types of optical elements.

In some implementations, light of the optical signal 160 with a wavelength near a boundary between two spectral bands 165 may be split by the separating element 102 such that respective portions of the light go into multiple spectral bands 165. Thus, in some implementations, a spectral component at or near a boundary between a first spectral band 165 of the plurality of spectral bands 165 and a second spectral band 165 of the plurality of spectral bands 165 may split such that a first portion of the spectral component is in the first spectral band 165 and a second portion of the spectral component is in the second spectral band 165. Here, a sum of the power of the first portion and a power of the second portion is a total power of the spectral component.

In the example shown in FIG. 5, the optical signal 160 includes a full spectrum originating from the sample 155 (e.g., as in FIG. 1). Here, each thin film interference filter 502 reflects only a fraction (e.g., a spectral band 165) of the full spectrum and transmits the remainder. In some implementations, as illustrated in FIG. 5, a sequence of multiple (e.g., four) interference filters 502, followed by a mirror 504, divides the full spectrum into multiple (e.g., five) spatially separated spectral bands 165, which are then incident on a focusing lens 506 to transform the spatial separation (e.g., offset) into an angular separation (e.g., angle) of the different spectral bands 165. The spectral bands 165 can then be imaged onto a plane for further optical processing. In the context of the optical device 100 described in FIG. 1, the spatially/angularly separated spectral bands 165 are then directed to the dispersive element 104.

In the examples shown in FIGS. 6 and 7, the optical signal 160, including the full spectrum originating from the sample 155 (e.g., as in FIG. 2), is collimated by a lens 604 and then directed onto a diffraction grating 602 which separates the incoming light into different spectral components (e.g., wavelengths). The diffracted light emerging from the diffraction grating 602 is then focused by a lens 606 and imaged to produce spatially and angularly separated spectral bands 165. The imaging system shown in FIG. 7 includes a wedge 702 and prisms 704a and 704b that serve to change optical path lengths and propagation angles of the beams of the spectral bands 165 in such a way that the emerging spectral beams appear to be coming from a single focal plane, but from different angles (e.g., similar to what is achieved in the example shown in FIG. 5). In the context of the optical device 100 described in FIG. 1, the spatially/angularly separated spectral bands 165 are then directed to the dispersive element 104.

As indicated above, FIGS. 5-7 are provided as examples. Other examples may differ from what is described with regard to FIGS. 5-7. The number and arrangement of elements shown in FIGS. 5-7 are provided as an example. In practice, there may be additional elements, fewer elements, different elements, or differently arranged elements than those shown in FIGS. 5-7. Furthermore, two or more elements shown in FIGS. 5-7 may be implemented within a single element, or a single element shown in FIGS. 5-7 may be implemented as multiple, distributed elements. Additionally, or alternatively, a set of elements (e.g., one or more elements) shown in FIGS. 5-7 may perform one or more functions described as being performed by another set of elements shown in FIGS. 5-7.

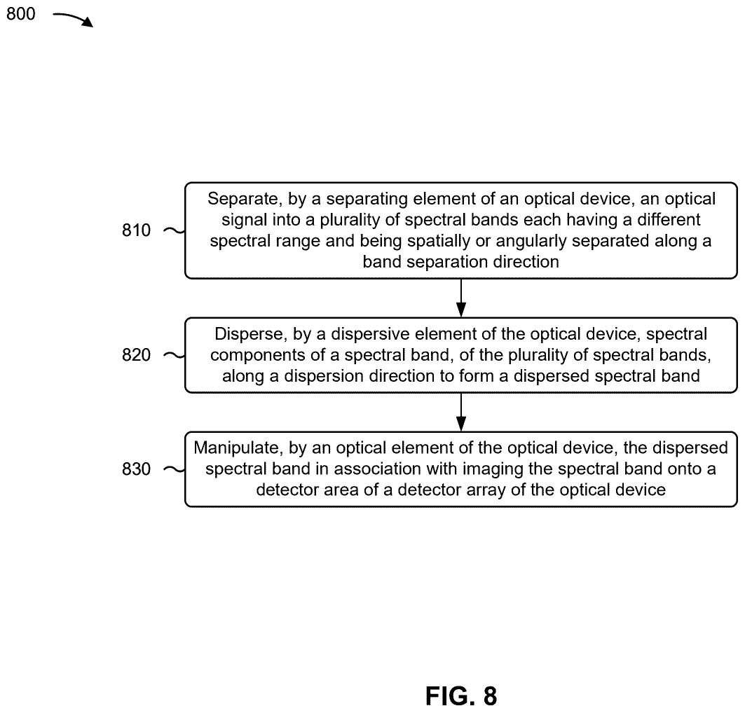

FIG. 8 is a flowchart of an example process 800 associated with a flex-spectrum optical detector described herein. In some implementations, one or more process blocks of FIG. 8 are performed by one or more elements of an optical device (e.g., optical device 100).

As shown in FIG. 8, process 800 may include separating an optical signal into a plurality of spectral bands each having a different spectral range and being spatially or angularly separated along a band separation direction (block 810). For example, a separating element 102 of the optical device 100 may separate an optical signal 160 into a plurality of spectral bands 165 each having a different spectral range and being spatially or angularly separated along a band separation direction, as described above.

As further shown in FIG. 8, process 800 may include dispersing spectral components of a spectral band, of the plurality of spectral bands, along a dispersion direction to form a dispersed spectral band (block 820). For example, a dispersive element 104 of the optical device 100 may disperse spectral components of a spectral band 165, of the plurality of spectral bands 165, along a dispersion direction to form a dispersed spectral band 165, as described above.

As further shown in FIG. 8, process 800 may include manipulating the dispersed spectral band in association with imaging the spectral band onto a detector area of a detector array of the optical device (block 830). For example, an optical element 106 of the optical device 100 may manipulate the dispersed spectral band 165 in association with imaging the spectral band 165 onto a detector area 110 of a detector array 108 of the optical device 100, as described above.

Process 800 may include additional implementations, such as any single implementation or any combination of implementations described below and/or in connection with one or more other processes described elsewhere herein. In a first implementation, a property (e.g., an optical resolution) of a first dispersed spectral band 165 of the plurality of dispersed spectral bands 165 differs from a property of a second dispersed spectral band 165 of the plurality of dispersed spectral bands 165.

In some implementations, at least one of a location, size, or orientation (direction) of a manipulated dispersed spectral band 165 formed by the manipulation of the dispersed spectral band 165 differs from a location, size, or orientation of a second manipulated dispersed spectral band 165 formed by manipulation of a second dispersed spectral band 165.

In some implementations, each spectral band 165 separated may be dispersed by the dispersive element 104 while in other implementations, one or more spectral bands 165 separated from the optical signal 160 may be directed away from the dispersive element 104 and/or detector array 118 (e.g., as shown with respect to spectral band 165b in FIG. 1).

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., an optical element or one or more optical elements) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical device, comprising:
a separating element to separate an optical signal into a plurality of spectral bands that are spatially or angularly separated along a band separation direction,
wherein spectral ranges differ among each spectral band of the plurality of spectral bands;
a dispersive element comprising a plurality of dispersive regions, wherein a dispersive region of the plurality of dispersive regions is to disperse spectral components of a spectral band, of the plurality of spectral bands, along a dispersion direction to form a dispersed spectral band;
a plurality of optical elements, wherein an optical element of the plurality of optical elements is to manipulate the dispersed spectral band in association with imaging the spectral band onto a detector area of a detector array; and
the detector array comprising the detector area.

2. The optical device of claim 1, wherein the band separation direction is perpendicular to the dispersion direction.

3. The optical device of claim 1, wherein the plurality of spectral bands are substantially non-overlapping.

4. The optical device of claim 1, wherein a spectral resolution of a first spectral band of the plurality of spectral bands is different from a spectral resolution of a second spectral band of the plurality of spectral bands.

5. The optical device of claim 1, wherein a bandwidth of a first spectral band of the plurality of spectral bands is different from a bandwidth of a second spectral band of the plurality of spectral bands.

6. The optical device of claim 1, wherein a spectrum formed by a sum of a set of spectral bands, of the plurality of spectral bands, that is imaged on the detector array is non-continuous.

7. The optical device of claim 1, wherein at least one spectral band of the plurality of spectral bands is not imaged onto any detector area of the detector array.

8. The optical device of claim 1, wherein an optical power of a spectral band, of the plurality of spectral bands, at the detector array is more than 90% of an optical power of the spectral band prior to the separating element.

9. The optical device of claim 1, wherein a spectral component at or near a boundary between a first spectral band of the plurality of spectral bands and a second spectral band of the plurality of spectral bands is split such that a first portion of the spectral component is in the first spectral band and a second portion of the spectral component is in the second spectral band, wherein a sum of a power of the first portion and a power of the second portion is a total power of the spectral component.

10. The optical device of claim 1, wherein the separating element comprises a plurality of thin film interference filters, each associated with a different spectral band of the plurality of spectral bands.

11. The optical device of claim 1, wherein the separating element comprises a diffraction grating.

12. The optical device of claim 1, wherein the plurality of dispersive regions are stacked along the band separation direction.

13. The optical device of claim 1, wherein a given dispersive region, of the plurality of dispersive regions, disperses a spectral band, of the plurality of spectral bands, incident thereon independently of dispersion by other dispersive regions of the plurality of dispersive regions.

14. The optical device of claim 1, wherein the optical element is to manipulate the dispersed spectral band such that a size of the dispersed spectral band along the dispersion direction matches a size of the detector area along the dispersion direction.

15. The optical device of claim 1, wherein the optical element is to manipulate the dispersed spectral band such that a size of the dispersed spectral band along the band separation direction matches a size of the detector area along the band separation direction.

16. The optical device of claim 1, wherein the plurality of optical elements are to manipulate the dispersed spectral bands such that images of the spectral bands are stacked along the band separation direction at a plane of the detector array.

17. The optical device of claim 1, wherein the plurality of optical elements are to provide spatial rearrangement of the plurality of spectral bands on a plane of the detector array.

18. The optical device of claim 1, wherein the detector array comprises a plurality of detector areas that are stacked along the band separation direction.

19. The optical device of claim 1, wherein the detector array is a two dimensional (2D) array.

20. The optical device of claim 1, wherein the detector array comprises one or more one dimensional (1D) detector arrays.

21. The optical device of claim 1, wherein the detector array is a single photon avalanche diode (SPAD) array.

22. The optical device of claim 1, wherein the detector array comprises an array of time-resolved photon counting detectors.

23. The optical device of claim 1, wherein the detector area comprises a plurality of detector areas, and a size of a first detector area of the plurality of detector areas is different from a size of a second detector area of the plurality of detector areas.

24. The optical device of claim 1, wherein the detector area comprises a plurality of detector areas, and a first spectral band of the plurality of spectral bands is imaged on a first detector area of the plurality of detector areas, a second spectral band of the plurality of spectral bands is imaged on a second detector area of the plurality of detector areas, wherein an optical resolution of the first spectral band matches an optical resolution of the second spectral band, a bandwidth of the first spectral band is smaller than a bandwidth of the second spectral band, and a total width and pixel size of the first detector area in the dispersion direction matches a total width and pixel size of the second detector area in the dispersion direction such that the first spectral band has a higher spectral resolution than the second spectral band.

25. The optical device of claim 1, wherein the detector area comprises a plurality of detector areas, and a size of a first detector area, of the plurality of detector areas, in the dispersion direction matches a size of a second detector area, of the plurality of detector areas, in the dispersion direction and a size of the first detector area in the band separation direction is different from a size of the second detector area in the band separation direction.

26. An optical device, comprising:
a separating element to separate an optical signal into a plurality of spectral bands having different spectral ranges and being spatially or angularly separated along a band separation direction;
a plurality of optical elements, wherein an optical element of the plurality of optical elements is to manipulate a spectral band, of the plurality of spectral bands, in association with imaging the spectral band onto a detector area; and
a detector array comprising the detector area.

27. The optical device of claim 26, further comprising a dispersive element including a plurality of dispersive regions, wherein a dispersive region of the plurality of dispersive regions is to disperse spectral components of the spectral band along a dispersion direction.

28. A method, comprising:
separating, by a separating element of an optical device, an optical signal into a plurality of spectral bands each having a different spectral range and being spatially or angularly separated along a band separation direction;
dispersing, by a dispersive element of the optical device, spectral components of a spectral band, of the plurality of spectral bands, along a dispersion direction to form a dispersed spectral band; and
manipulating, by an optical element of the optical device, the dispersed spectral band in association with imaging the spectral band onto a detector area of a detector array of the optical device.

29. The method of claim 28, wherein a property of a first dispersed spectral band of the plurality of dispersed spectral bands differs from a property of a second dispersed spectral band of the plurality of dispersed spectral bands.

30. The method of claim 28, wherein at least one of a location, size, or orientation of a manipulated dispersed spectral band formed by the manipulation of the dispersed spectral band differs from a location, size, or orientation of a second manipulated dispersed spectral band formed by manipulation of a second dispersed spectral band.
